(19) United States
(12) Patent Application Publication
(10) Pub. No.: US 2021/0083540 A1
(43) Pub. Date: Mar. 18, 2021

(54) STATOR FOR AN ELECTRICAL MACHINE AND METHOD FOR PRODUCING SAID STATOR

(71) Applicant: BRUSA ELEKTRONIK AG, Sennwald (CH)

(72) Inventor: Daniel Oeschger, St. Gallen (CH)

(21) Appl. No.: 16/962,476

(22) PCT Filed: Jan. 16, 2019
(86) PCT No.: PCT/EP2019/051038

§ 371 Date: Jul. 15, 2020

(30) Foreign Application Priority Data
Jan. 19, 2018 (DE) 10 2018 101 231.4

(51) Int. Cl. H02K 3/28; H02K 1/16; H02K 3/50; H02K 15/02; H02K 15/00; H02K 3/12

(52) U.S. Cl. CPC H02K 3/28; H02K 1/16; H02K 3/12; H02K 15/024; H02K 15/0068; H02K 3/50

(57) ABSTRACT

A stator for an electrical machine, the stator having a yoke with longitudinal grooves, which extend along an inner peripheral edge parallel to a longitudinal axis of the yoke and are separated by stator teeth, wherein compressed strands are inserted into the longitudinal grooves, which strands each consist of individual wires, wherein respective ends of the strands exit the grooves at a yoke head and protrude from the yoke, while extending parallel to the axis, wherein the wires of each strand are electrically conductively connected at ends of the strand, and a first end of a first strand, which protrudes from one yoke head, is electrically conductively joined to a second end of a second strand, which protrudes from the one yoke head and comes from another groove, by a separate electrically conductive connecting element to form an electrical winding, the first end and the second end mechanically not touching.

### CROSS REFERENCE TO RELATED APPLICATIONS

This application is the U.S. National Phase of, and Applicant claims priority from, International Patent Application No. PCT/EP2019/051038, filed on 16 Jan. 2019, and German Patent Application No. DE 10 2018 101 231.4, fled on 19 Jan. 2018, both of which are incorporated herein by reference in their entirety.

### FIELD

The invention relates to a stator for an electrical machine, in particular an induction machine such as an electric motor and/or a generator, in particular for an electric or hybrid vehicle. Furthermore, the invention relates to a method for producing such a stator, an electric motor or a generator with such a stator, and a vehicle, i.e. a motor vehicle, a watercraft, an underwater vehicle, an aircraft or a spacecraft with such an electric motor and/or generator.

### SUMMARY

The object of the invention is to provide a stator for an electrical machine, which has a more compact design and allows a lower weight due to a lower use of material, and thus enables the same or higher performance potential of the electrical machine than stators previously known in the prior art.

The invention results from the features of the independent claims. Advantageous further refinements and embodiments are the subject of the dependent claims. Further features, potential applications, and advantages of the invention result from the following description and from the explanation of embodiments of the invention, which are shown in the drawings.

A first aspect of the invention relates to a stator for an electrical machine, in particular for an electric motor and/or a generator, wherein the stator has a stator yoke which has longitudinal grooves extending along its inner peripheral edge and parallel to it along a longitudinal axis LA of the stator yoke, each of which are separated by stator teeth. The stator yoke advantageously has a basically cylindrical shape. The longitudinal grooves and the stator teeth are arranged on the inside of this cylindrical shape. In the longitudinal grooves (between the stator teeth) one or more compressed strands are introduced, each consisting of several, each electrically insulated individual wires. Respective ends of the compressed strands exit the longitudinal grooves of the stator yoke at a respective stator yoke head and protrude from the stator yoke along the longitudinal axis LA by a specified length L.

The individual wires of the compressed strands advantageously consist of copper or a copper alloy or of aluminum or an aluminum alloy. All of the compressed strands introduced into the longitudinal grooves of the stator yoke are advantageously of identical design. Furthermore, the ends of the compressed strands protrude from the stator yoke in an orientation parallel to the longitudinal axis LA of the stator yoke or standing vertically on the stator yoke head. Accordingly, the compressed strands are not bent after exiting the longitudinal grooves. They thus have an overall length which is determined from the length LS of the stator yoke and the respective protrusions L on the two stator yoke heads.

In the present case, the term “stator yoke head” means the end faces of the stator yoke. These are generally perpendicular to the longitudinal axis LA of the stator yoke.

The total length GL of a compressed strand results in an advantageous variant of GL=2*L+LS, where LS indicates the dimension of the stator yoke along the longitudinal axis LA. In this variant, the respective ends of the compressed strands protrude from the stator yoke at both stator yoke heads by a uniform length L. In another advantageous variant, the ends of the compressed strands protrude from the stator yoke by a uniform length L1 with the first stator yoke head and by a uniform length with the second stator yoke head L2. In this case, the total length GL of a compressed strand is: GL=L1+L2+LS. The ends of the compressed strands advantageously protrude uniformly from the stator yoke at the respective stator yoke head by a constant length L/L1/L2. The length L/L1/L2 is advantageously dimensioned such that the respective end of a compressed strand inserted into the stator yoke is mechanically joined to one end of a respective electrical connecting element and can thus also be electrically connected. It is advantageous to choose the protruding length L required for this to be as small as possible, but sufficiently large so that the joining process of the ends of the compressed strands with the respective connecting element can be carried out sufficiently well.

The length L/L1/L2 is advantageously chosen from the range 2 mm to 50 mm, or the length L/L1/L2 is 15 mm, 7 mm, 19 mm, 13 mm, 15 mm, 20 mm, 23 mm, 25 mm, 27 mm, 30 mm, 33 mm, 35 mm, 37 mm, 40 mm, 43 mm, 45 mm or 47 mm. These values apply in particular to electrical machines, which are used in vehicles, in particular motor vehicles.

The individual wires of each compressed strand introduced into the longitudinal grooves are electrically conductively connected at their ends according to the invention. In other words, in the section in which the individual wires run within the stator yoke in the respective longitudinal groove, the individual wires each have an insulation, which electrically insulates them from other individual wires of the compressed strand, from further compressed strands introduced into the longitudinal groove, and from the stator yoke. The electrical connection of the individual wires is thus advantageously arranged outside the stator yoke.

Finally, according to the invention, at least a first end of a first compressed strand protruding from one of the stator yoke heads is mechanically and electrically connected to a second end of another, second compressed strand protruding beyond the same stator yoke head and coming from a different longitudinal groove to form an electrical winding via a separate electrically conductive connecting element, wherein the first end and the second end do not mechanically touch each other.

Such a connecting element thus connects at least two ends of two compressed strands coming from different longitudinal grooves of the stator yoke on a stator yoke head. Depending on the configuration of the windings of the stator, connecting elements according to the invention are further used which electrically connect three or more ends of three or more compressed strands coming from one of the several different longitudinal grooves on a stator yoke head. Advantageously, one or more of the connecting elements have connection interfaces for the electrical control of the electrical windings formed in each case from the compressed strands and the connecting elements.

The conductive connecting element is advantageously a metal bracket, in particular made of copper or a copper alloy or of aluminum or an aluminum alloy. The conductive connecting element is advantageously curved in its longitudinal direction. The connecting element advantageously has a web-like, staple-like, beam-like or U-shaped longitudinal profile. The connecting element advantageously has a cross-section along its longitudinal direction, which is equal to or smaller than a sum of the cross-sections of all the individual wires of a compressed strand, which is directly connected to the connecting element. In an alternative embodiment, the connecting element has a cross-section along its longitudinal direction (in the direction of current flow), which is greater than a sum of the cross-sections of all the individual wires of a compressed strand, which is connected directly to the connecting element. In an alternative embodiment, the connecting element has a changing cross-section along its longitudinal direction (in the direction of current flow), which cross-section along the longitudinal direction is sometimes larger, equal to and smaller than a sum of the cross-sections of all the individual wires of a compressed strand directly connected to the connecting element.

The electrical resistance and the associated local heat development on the connecting element can thus be set accordingly. As described later, thermal contact to a heat sink is advantageously produced at points of high local heat development in order to dissipate heat that is produced. In particular, cross-sections that are larger than a sum of the cross-sections of all the individual wires of a compressed strand directly connected to the connecting element, serve to reduce the electrical resistance. The connecting element has a width B perpendicular to it along its longitudinal extent and a thickness D perpendicular to the longitudinal extent and width B. Preferably, the following applies: D<B/2. The connecting element advantageously has at least two sections along its longitudinal extent, the cross sections of which (perpendicular to the longitudinal axis LA) differ.

The connecting element is advantageously produced from an at least simply folded metal sheet, in particular from copper sheet.

A particularly advantageous development of the stator is characterized in that the connecting element and the mechanically and electrically connected ends of the compressed strands project from the stator yoke at each stator head by a total length L/L1/L2 which is smaller than a limit value G1, wherein the limit value G1 is smaller than ten times the largest diameter D of a cross-section of the compressed strands: L/L1/L2<G1, where: G1<10*D.

In particular, by a minimal protrusion of the ends of the compressed strands on the respective stator yoke head and the proposed type of electrical connection of the ends of two or more compressed strands at the respective stator yoke head via an electrically conductive separate connecting element, the overall length of the stator with windings can be reduced. This is accompanied by corresponding material savings and thus a weight reduction of the proposed stator.

The individual wires of each of the compressed strands arranged in the longitudinal grooves of the stator are preferably mechanically compacted at the two ends of the compressed strands by ultrasonic welding and connected in an electrically conductive manner. Of course, other known methods for electrically connecting the ends of the respective individual wires are also encompassed by the present inventive concept. For example, resistance welding methods or soldering methods are also suitable for the simple production of a stable and electrically conductive connection of the individual wires at the ends of the compressed strand.

Advantageously, the first end of a first compressed strand protruding from the stator yoke head is joined to a first end of the connecting element and the second end of a second compressed strand protruding from the stator yoke head and coming from another longitudinal groove, is joined to a second end of the element. Joining or the joining process means, in the present case: Welding, soldering, gluing, clamping, screwing etc. The ends of the compressed strands are advantageously firmly joined to the connecting element. The joining of the first end of the first compressed strand to the first end of the connecting element and the second end of the second compressed strand to the second end of the connecting element is particularly advantageously carried out by laser welding.

Advantageously, each of the compressed strands introduced into the longitudinal grooves has an electrically insulating sheath, at least in the region of the respective compressed strand running in the longitudinal groove, which sheath electrically insulates the respective compressed strand from any further compressed strands introduced into the respective longitudinal groove and from the stator yoke.

The individual wires of at least one of the compressed strands are advantageously twisted. The individual wires of all compressed strands are advantageously twisted. The individual wires are advantageously twisted such that the lay lengths of the twisting of the individual wires correspond to a length LS of the stator yoke or are smaller. The term “lay length” denotes the length along, for example, a twist axis of the twisted individual wires in question, which corresponds to a 360° twist. The lay lengths of the twists of the individual wires advantageously correspond to an integer divisor of the length LS of the stator yoke. The number of twists of the twist along the length LS, i.e., the number of 360° twists along the length LS, is in each case an integer. In a further advantageous embodiment, a plurality of lay lengths can be assigned to a single wire by under-twisting.

One or more ends of the compressed strands are advantageously electrically connected to a motor terminal board. The motor terminal board is used for the electrical connection of the stator windings consisting of the compressed strands and the connecting elements. One or more of the connecting elements advantageously have an electrical connection to the motor terminal board.

The end faces of at least a third of all connecting elements (advantageously all connecting elements) are preferably arranged of a stator yoke head in a plane perpendicular to the longitudinal axis LA. The end faces of the connecting elements are the surfaces of the connecting elements that are most elevated along the longitudinal axis LA relative to the respective stator yoke head.

The connecting elements advantageously have electrical insulation which prevents short circuits between connecting elements, i.e., each of the connecting elements is electrically insulated from other connecting elements arranged adjacent to the respective stator yoke head. For this purpose, the connecting elements themselves preferably have an electrically insulating surface. Alternatively or additionally, an insulating material is introduced between adjacent connecting elements.

One or more of the connecting elements are advantageously thermally connected to a heat sink. This thermal coupling enables the connecting elements to be cooled, so that a considerable portion of the thermal energy generated during operation of the electrical machine having the stator can be dissipated.

Another aspect of the invention relates to an electric motor and/or a generator with a stator, as described above.

Another aspect of the invention relates to a vehicle, in particular a motor vehicle, a watercraft, an underwater vehicle, an aircraft or a spacecraft with an electric motor and/or a generator, as described above.

A last aspect of the invention relates to a method for producing a stator with a stator yoke for an electrical machine, in particular for an electric motor and/or a generator. The proposed procedure includes the following steps.

In one step, a stator yoke is provided which, along its inner peripheral edge, has longitudinal grooves, which extend parallel and along a longitudinal axis LA of the stator yoke, and which are each separated by stator teeth.

In a further step, compressed strands are provided, each consisting of several electrically insulated individual wires.

In a further step, one or more of the compressed strands are introduced into the respective longitudinal grooves, wherein respective ends of the compressed strands exit the longitudinal grooves of the stator yoke on a respective stator yoke head and protrude from the stator yoke by a specified length L along the longitudinal axis.

In a further step, there is a mechanical and electrical connection of at least a first end of a first compressed strand projecting from one of the stator yoke heads to a second end of another, second compressed strand protruding from same stator yoke head and coming from another longitudinal groove to form an electrical winding via a separate electrically conductive connecting element, wherein the first end and the second end do not mechanically touch each other.

The individual wires of each of the compressed strands provided are advantageously electrically conductively connected at their ends, before the compressed strands are introduced into the longitudinal grooves. For this purpose, the individual wires at the ends of the compressed strands are advantageously mechanically compacted by ultrasonic welding, and then electrically conductively connected using a joining method, preferably by laser welding.

Alternatively, the individual wires of each of the compressed strands provided are electrically conductively connected at their ends, only after they have been introduced into the respective longitudinal grooves of the stator yoke. As stated above, this is preferably carried out by ultrasonic compacting and subsequent laser welding.

The mechanical and electrical connection of at least the first end of the first compressed strand protruding from a stator yoke head to a second end of another, second compressed strand protruding from the same stator yoke head and coming from a different longitudinal groove, advantageously takes place in order to form an electrical winding via a separate electrically conductive connecting element by a welding process, in particular laser welding, or a soldering process according to which the first and second compressed strands are introduced into the stator yoke.

Further advantageous embodiments of the proposed method result from an analogous implementation of the statements made above for the stator.

Further advantages, features, and details result from the following description, in which —if necessary with reference to the drawings—at least one example embodiment is described in detail. Identical, similar, and/or functionally identical parts are provided with the same reference numerals.

### BRIEF DESCRIPTION OF THE DRAWINGS

In the drawings:

FIG. 1 shows a stator with electrically and mechanically connected compressed strands (prior art);

FIG. 2 is a schematic representation of a stator according to one embodiment of the invention;

FIG. 3 is a top view of the stator yoke head 110a of the stator according to FIG. 2;

FIG. 4 is a top view of the stator yoke head 110b of the stator according to FIG. 2;

FIG. 5a is a schematic view of the end face of a connecting element 114;

FIG. 5b is a schematic side view of a connecting element according to FIG. 5a in a first variant;

FIG. 5c is a schematic side view of a connecting element according to FIG. 5a in a second variant; and

FIG. 6 is a schematic representation of a method according to the invention for producing a stator.

### DETAILED DESCRIPTION

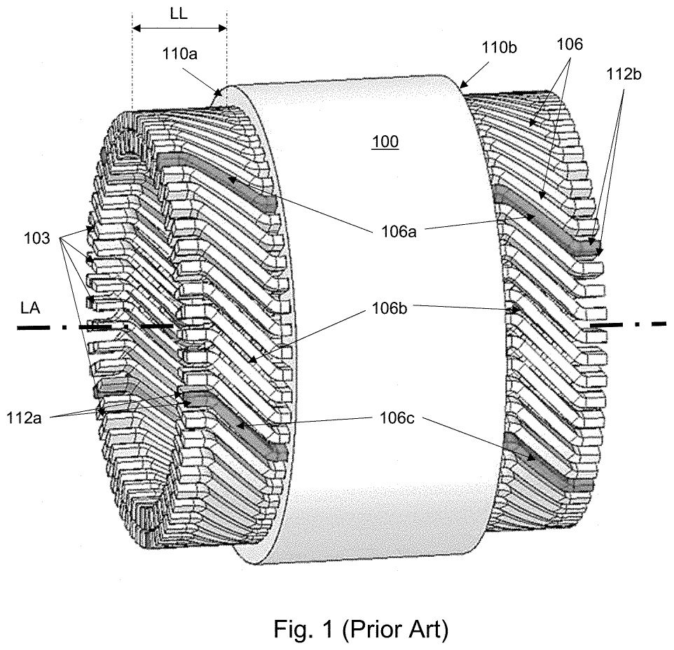

FIG. 1 shows a stator for an electrical machine, in particular an electric motor and/or a generator with electrically and mechanically connected compressed strands according to the prior art. The stator shown has a fundamentally cylindrical stator yoke 100 which, along its inner peripheral edge, has left grooves (not shown) which extend parallel to a longitudinal axis LA of the stator yoke 100 and are each separated by stator teeth (not shown).

In the present case, two compressed strands 106 are introduced into the longitudinal grooves, each of which consists of a plurality of individual wires (not shown), each of which is electrically insulated. The respective compressed strands 106 exit the longitudinal grooves of the stator yoke 100 on the respective stator yoke heads 110a, 110b and then run at an angle such that they are mechanically and electrically connected to the respective ends 112a, 112b of the compressed strands to form stator windings with a different compressed strand of another longitudinal groove.

For example, the end 112b of the compressed strand 106a is electrically and mechanically connected to form the end 112b of the compressed strand 106b (runs behind the visible compressed strand of the outer ring). The compressed strand 106b is also electrically and mechanically connected at its end 112a directly to the end 112a of the compressed strand 106c, etc. This type of electrical connection of the ends 112a, 112b of the compressed strand 106, 106a-106c protrudes from the stator yoke heads by a length LL.

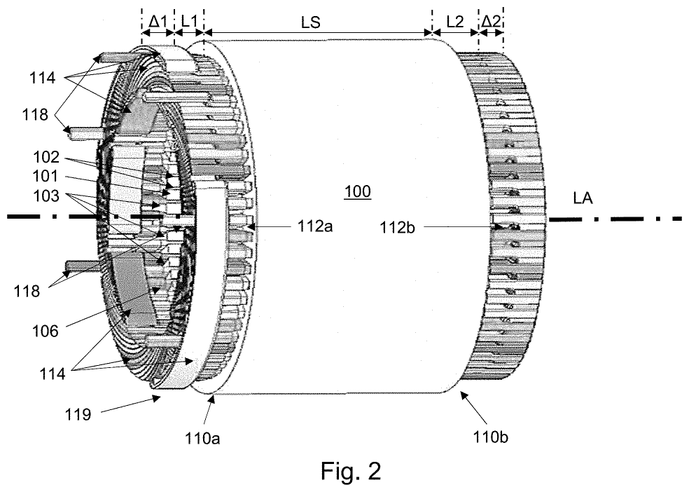

FIG. 2 shows a schematic representation of a stator for an electrical machine, in particular for an electric motor and/or a generator according to an example embodiment of the invention, wherein the stator, as in FIG. 1, has a stator yoke 100 which has longitudinal grooves 101 that extend parallel along its inner peripheral edge along a longitudinal axis LA of the stator yoke 100, which grooves are each separated by stator teeth 102. As in FIG. 1, one or more compressed strands 106 are each introduced into the longitudinal grooves 101, each of which consists of a plurality of electrically insulated individual wires (not shown). The individual wires of the compressed strands 106 are connected in an electrically conductive manner at their ends 112a, 112b.

In contrast to FIG. 1, the respective ends 112a, 112b of the compressed strands 106 exit the longitudinal grooves 101 of the stator yoke 100 on the respective stator yoke head 110a, 110b parallel to the longitudinal axis LA and thus protrude from the respective stator yoke head according to the invention in a parallel orientation to the longitudinal axis LA by a specified length L. The compressed strands 106 thus run essentially straight from one end 112a to the opposite end 112b. The length L for the left stator yoke head 110a is uniformly L1 for all compressed strands 106 and for the right stator yoke head 110b uniformly L2 for all compressed strands 106. In the present case, L1≠L2. In the present case, however, all of the compressed strands 106 have the same length. The following may apply in other example embodiments according to the invention: L1=L2=L. For special applications, the length L on a stator yoke head 110a, 110b can also be different for at least two compressed strands.

Furthermore, in contrast to FIG. 1, at least a first end 112a, 112b of a first compressed strand 106 protruding from one of the stator yoke heads 110a, 110b is electrically conductively joined to a second end 112a, 112b of another, second compressed strand 106 protruding from the same stator yoke head 110a, 110b and coming from another longitudinal groove 104 to form an electrical winding via a separate electrically conductive connecting element 114, wherein the first end 112a, 112b and the second end 112a, 112b do not mechanically touch each other.

It can also be seen from FIG. 2 that some of the connecting elements 114 have on their end face 119 coaxial to the longitudinal axis LA connecting pins 118 which rise above the stator yoke 100 and are used for electrical contacting of the windings realized in the stator 100. Some of the connecting elements 114 serve for the electrical connection of two compressed strand ends 112a, 112b. In turn, some connecting elements 114 are used here for the electrical connection of three compressed strand ends 112a, 112b.

The connecting elements 114 shown here are copper strips bent in the longitudinal direction with a strip width Δ1 or Δ2 in the range from 5 mm to 40 mm and a strip thickness of 0.2 mm to 5 mm. The overall length BL of the stator shown in the present example embodiment results in: BL=Δ1+L1+LS+L2+Δ2. In comparison to the stator of FIG. 1, the stator of FIG. 2, as far as the winding guidance outside of the stator yoke 100 is concerned, is more compact and thus saves material and weight.

The major part of the heat generated during operation of the electrical machine can be dissipated by thermal contact of the connecting elements 114 with a heat sink. It is advantageous for the thermal coupling for heat dissipation that the end faces 119 of the connecting elements 114 on the respective stator yoke head 110a, 110b are essentially in a plane perpendicular to the longitudinal axis LA. In terms of construction technology, this makes it possible to easily implement various known heat couplings. It is essential here that the thermal coupling is made from a non-electrically conductive material.

The compressed strand ends 112a, 112b protruding from the stator yoke 100 are advantageously connected to the respective connecting element by ultrasonic compacting and subsequent laser welding.

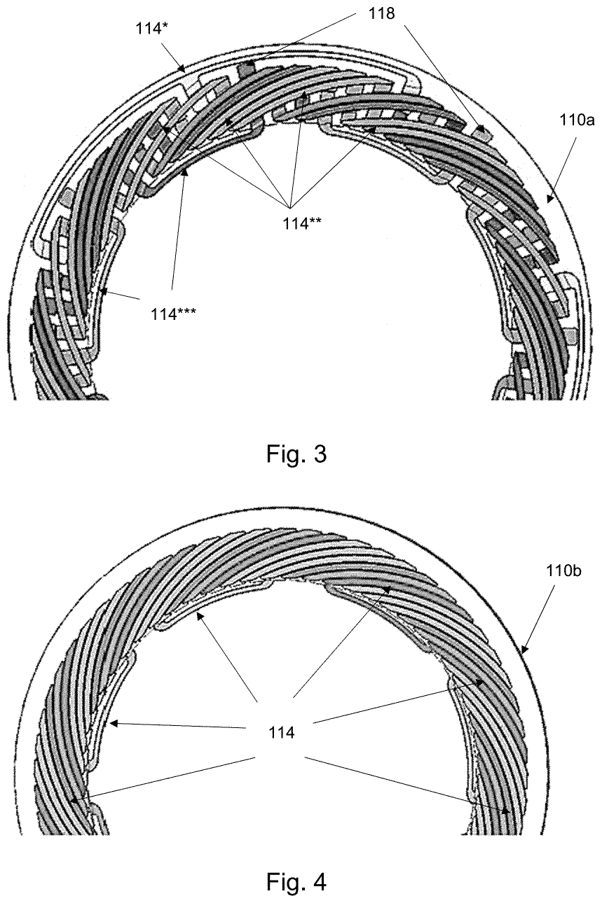

FIG. 3 shows a top view of the stator yoke head 110a of the stator yoke 100 according to FIG. 2. In this top view, the end faces of the connecting elements 114, which are each curved in the longitudinal direction, can be clearly seen. A plurality of the connecting elements 114**/114*** connect the ends of two compressed strands protruding from the stator yoke 110 on the stator yoke head 110a. Some of the connecting elements 114* connect the ends of three compressed strands protruding from the stator yoke 110 on the stator yoke head 110a. Furthermore, some of the ends of the compressed strands are electrically connected to a connecting pin 118, which is used to connect the electrical windings realized in the stator yoke 100.

FIG. 4 shows a top view of the stator yoke head 110b of the stator yoke according to FIG. 2. The end faces of the connecting elements 114, which are each curved in the longitudinal direction, can also be clearly seen in this top view.

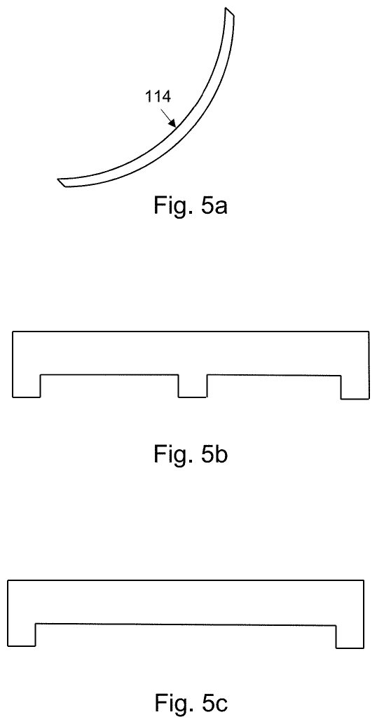

FIG. 5a shows a schematic plan view of the end face of a connecting element 114, preferably made of copper.

FIG. 5b shows a schematic side view of a connecting element 114 according to FIG. 5a in a first variant. FIG. 5c shows a schematic side view of a connecting element according to FIG. 5a in a second variant.

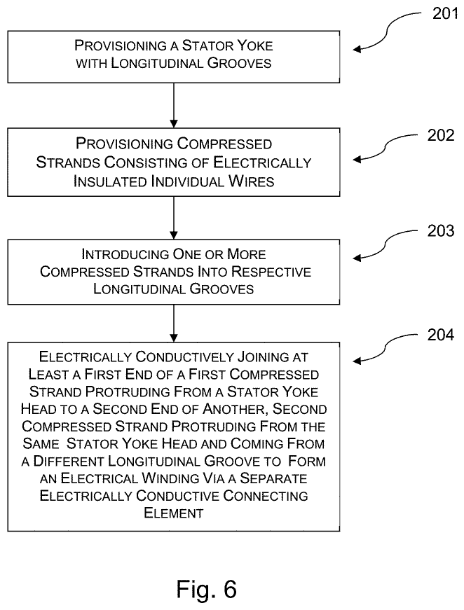

FIG. 6 shows a schematic representation of a method according to the invention for producing a stator with a stator yoke 100 for an electrical machine, in particular for an electric motor and/or a generator. The method includes the following steps.

In step 201, a stator yoke 100 is provided which, along its inner peripheral edge, has longitudinal grooves (101) extending parallel and along a longitudinal axis LA of the stator yoke (100), each of which is separated by stator teeth (102). In step 202, compressed strands 106 are provided, each consisting of a plurality of electrically insulated individual wires. In step 203, one or more compressed strands 106 are introduced into the respective longitudinal grooves 101, wherein respective ends 112a, 112b of the compressed strands 106 exit the longitudinal grooves 101 of the stator yoke 100 on a respective stator yoke head 110a, 110b and protrude from the stator yoke 100 along the longitudinal axis LA by a specified length L. In step 204, there is an electrically conductive joining of at least a first end 112a, 112b of a first compressed strand 106 protruding from one of the stator yoke heads 110a, 110b to a second end 112a, 112b of another, second compressed strand 106 protruding from the same longitudinal stator yoke head 110a, 110b to form an electrical winding via a separate electrically conductive connecting element 114, wherein the first end (112a, 112b) and the second end 112a, 112b do not mechanically touch each other.

Although the invention has been illustrated and explained in greater detail using preferred example embodiments, the invention is not limited by the disclosed examples and other variations may be derived therefrom by a person skilled in the art without departing from the scope of protection of the invention. It is therefore clear that there are a plurality of possible variations. It is also clear that embodiments cited by way of example actually only constitute examples that are not to be interpreted in any way as a limitation of the scope, of the potential applications, or of the configuration of the invention. Instead, the preceding description and the description of the figures enable the person skilled in the art to specifically implement the example embodiments, wherein the person skilled in the art has knowledge of the disclosed inventive concept and is able to make numerous changes, for example, with respect to the function or the arrangement of individual elements cited in an example embodiment, without departing from the scope of protection, which is defined by the claims and their legal equivalents, such as a further explanation in the description.

### LIST OF REFERENCE NUMERALS

100 Stator yoke
101 Internal longitudinal grooves in the stator yoke
102 Stator teeth
103 Mechanical and electrical connection of two ends of two compressed strands
106 Compressed strands
106a, 106b, 106c Compressed strands
110a, 110b Stator yoke head
112a, 112b Ends of the compressed strands, preferably with compacted and electrically connected individual wires
114 Connecting element
118 Connecting pin
119 End face
201-204 Method steps

1. A stator for an electrical machine, the stator comprising:
a stator yoke that has longitudinal grooves, which extend along an inner peripheral edge of the stator yoke, parallel to a longitudinal axis LA of the stator yoke and each of which is separated by stator teeth (102); and
one or more compressed strands inserted into the longitudinal grooves, the compressed strands each consist of a plurality of individual wires, which are each electrically insulated,
wherein respective ends of the compressed strands exit the longitudinal grooves of the stator yoke at a stator yoke head and each protrude from the stator yoke, while extending parallel to the longitudinal axis LA, by a specified length L,
wherein the individual wires of each compressed strand are electrically conductively connected at the ends of the compressed strand, and
at least one first end of a first compressed strand, which first compressed strand protrudes from one of the stator yoke heads, is electrically conductively joined to a second end of another, second compressed strand, the second compressed strand protrudes from the same stator yoke head and comes from another longitudinal groove, by a separate electrically conductive connecting element in order to form an electrical winding, wherein the first end and the second end mechanically do not touch each other.

2. The stator according to claim 1, wherein the connecting element is designed as a metal bracket.

3. The according to claim 1, wherein the connecting element is bent along its longitudinal direction.

4. The stator according to claim 1, wherein the connecting element is designed as a bent copper band.

5. The stator according to claim 1, a wherein the connecting element has a web-like, staple-like, beam-like, or U-shaped longitudinal profile.

6. The stator according to claim 1, wherein end faces of the connecting elements lie essentially in a plane arranged perpendicular to the longitudinal axis.

7. The stator according to claim 1, wherein the connecting elements have two or three contact projections extending perpendicular to a longitudinal direction of the connecting element.

8. The stator according to claim 1, wherein the connecting element has a changing cross-section in a direction of current flow, the cross-section is sometimes larger, equal, and smaller than a sum of the cross-sections of all the individual wires of a compressed strand directly connected to the connecting element.

9. The stator according to claim 1, wherein ends of a compressed strand protrude from the stator yoke heads by a length L which is smaller than a limit value G1, wherein the limit value G1 is smaller than ten times the largest diameter D of a cross-section of the compressed strands: G1<10*D.

10. The stator according to claim 1, wherein the individual wires of each compressed strand are mechanically compacted at their ends by ultrasound and electrically connected by laser welding.

11. The stator according to claim 1, wherein the first end is electrically conductively joined by laser welding to a first end of the connecting element and the second end is electrically conductively joined by laser welding to a second end of the connecting element.

12. The stator according to claim 1, in wherein each of the compressed strands, at least in an area in which the compressed strands run in the longitudinal grooves, has an electrically insulating sheathing, which electrically insulates the respective compressed strand from other compressed strands introduced in the respective longitudinal groove and from the stator yoke.

13. The stator according to claim 1, wherein the conductive connecting element is curved in its longitudinal direction.

14. The stator according to claim 1, wherein end faces of at least one third of all joined connecting elements of a stator yoke head lie in a plane which is substantially perpendicular to the longitudinal axis LA.

15. The stator according to claim 1, wherein one or more of the connecting elements are thermally connected to a heat sink.

16. An electric motor or generator with a stator according to claim 1.

17. A vehicle with the electric motor or generator according to claim 16.

18. (canceled)

19. The vehicle according to claim 17, wherein the vehicle is a motor vehicle, a rail vehicle, a watercraft, an underwater vehicle, a spacecraft, a golf cart, a cable-guided shuttle, an industrial truck, a hoist, an aircraft, a construction machine, or a machine tool.

20. A method of producing a stator with a stator yoke for an electrical machine, the method comprising:
provisioning a stator yoke which has longitudinal grooves extending along its inner peripheral edge and parallel to it along a longitudinal axis LA of the stator yoke, each of the longitudinal grooves being separated by stator teeth;
provisioning compressed strands, each consisting of several electrically insulated individual wires;
introducing one or more compressed strands into the respective longitudinal grooves, wherein respective ends of the compressed strands exit the longitudinal grooves of the stator yoke at a respective stator yoke head and protrude from the stator yoke parallel to the longitudinal axis LA by a specified length L; and
electrically conductively joining at least a first end of a first compressed strand protruding from one of the stator yoke heads to a second end of another, second compressed strand protruding from the same stator yoke head and coming from a different longitudinal groove to form an electrical winding via a separate electrically conductive connecting element, wherein the first end and the second end do not mechanically touch each other.
